(19) United States
(12) Patent Application Publication
(10) Pub. No.: US 2020/0136228 A1
(43) Pub. Date: Apr. 30, 2020

(54) Inflatable Antenna and Associated Assemblies

(71) Applicant: Shakespeare Company, LLC, Greer, SC (US)

(72) Inventors: Andrew Atkinson, Yorkshire (GB); Dave Manasseh, Yorkshire (GB); Clayton Smith, Yorkshire (GB)

(21) Appl. No.: 16/624,119

(22) PCT Filed: Jun. 15, 2018
(86) PCT No.: PCT/US2018/037689

§ 371 Date: Dec. 18, 2019

Related U.S. Application Data
(60) Provisional application No. 62/521,970, filed on Jun. 19, 2017.

(51) Int. Cl. H01Q 1/08; H01Q 15/14

(52) U.S. Cl. CPC H01Q 1/081; H01Q 15/14

(57) ABSTRACT

An inflatable antenna may include an inflatable sock, an antenna, and an attachment port. The inflatable sock may have an inflated state and a deflated state, where the inflatable sock assumes an elongated inflated shape in the inflated state. The antenna may extend along the length of the inflatable sock. The attachment port may be configured for operable connection to an inflation mechanism.

### CROSS-REFERENCE TO RELATED APPLICATIONS

This application claims priority benefit of U.S. Provisional Application No. 62/521,970, filed Jun. 19, 2017, which is incorporated by reference herein.

### TECHNICAL FIELD

The present disclosure relates to antennas, and in particular, to inflatable antennas and associated assemblies.

### BACKGROUND

Large marine antennas are often unsightly and take up a great deal of space. A typical marine antenna is composed of a rigid plastic shell surrounding an antenna that permits communications to and from a receiver and/or a transmitter. While a larger antenna may increase the antenna's range and performance, smaller vessels often do not have space for a large, permanently fixed marine antenna. Smaller vessels, instead, carry either a handheld radio or have a smaller antenna system attached to the boat. However, in an emergency, the smaller antenna system may not be sufficient to contact a nearby vessel or the coast guard. Therefore, any improvements in antenna storage, range, and/or overall aesthetics would be useful.

### SUMMARY

In one aspect, an inflatable antenna is provided, including an inflatable sock having an inflated state and a deflated state. The inflatable sock assumes an elongated inflated shape in the inflated state. The inflatable antenna also includes an antenna extending along the length of the inflatable sock and an attachment port configured for operable connection to an inflation mechanism.

In another aspect, an inflatable antenna assembly is provided, including an inflatable antenna having an inflatable sock with an elongated shape. An antenna extends along a length of the inflatable sock. The inflatable antenna also includes an attachment port. The inflatable antenna assembly includes an inflation mechanism configured for operable attachment to the attachment port. The inflation mechanism is configured to selectively inflate the inflatable sock.

In another aspect, an inflatable antenna assembly is provided, including a bag with a stiffened portion and an inflatable antenna coupled to the stiffened portion within the bag.

In yet another aspect, an inflatable antenna assembly is provided, including a structural component and an inflatable antenna. The inflatable antenna is coupled to the structural component. The inflatable antenna includes an inflatable sock with an elongated inflated shape and an antenna extending along the length of the inflatable sock.

### BRIEF DESCRIPTION OF THE DRAWINGS

Referring now to the drawings, which are meant to be exemplary and not limiting, and wherein like elements are numbered alike. The detailed description is set forth with reference to the accompanying drawings illustrating examples of the disclosure, in which use of the same reference numerals indicates similar or identical items. Certain embodiments of the present disclosure may include elements, components, and/or configurations other than those illustrated in the drawings, and some of the elements, components, and/or configurations illustrated in the drawings may not be present in certain embodiments.

FIG. 1 is a front perspective view of one embodiment of a bag for an inflatable antenna assembly.

FIG. 2 is a rear perspective view of the bag of FIG. 1 having a series of loop fastener strips.

FIG. 3 is a side cross-sectional view of one embodiment of an antenna assembly prior to inflation.

FIG. 4 is a front view of one embodiment of an antenna.

FIG. 5 is a partial cross-sectional plan view of one embodiment of an inflatable sock and antenna of an inflatable antenna assembly.

FIG. 6 is a side view of one embodiment of an inflatable antenna in an inflated state.

FIG. 7 is a side view of one embodiment of an inflatable antenna in an inflated state and coupled to a structure.

FIG. 8 is a top view of the inflatable antenna of FIG. 6.

FIG. 9 is a side view of the inflatable antenna of FIG. 6.

### DETAILED DESCRIPTION

Referring now to the drawings, exemplary illustrates are shown in detail. The various features of the exemplary approaches illustrated and described with reference to any one of the figures may be combined with features illustrated in one or more other figures, as it will be understood that alternative illustrations that may not be explicitly illustrated or described may be able to be produced. The combinations of features illustrated provide representative approaches for typical applications. However, various combinations and modifications of the features consistent with the teachings of the present disclosure may be desired for particular applications or implementations. The representative illustrations below relate generally to antennas and in particular to inflatable emergency antennas. Artisans may recognize similar applications or implementations with other technologies and configurations.

In some embodiments, an inflatable antenna assembly includes a bag (used herein to refer to any suitable container or substrate for the antenna) with a stiffened portion and an inflatable antenna attached to the stiffened portion of the bag. The inflatable antenna includes an inflatable sock with an interior surface and an exterior surface where an antenna extends along the inflatable sock. On the exterior surface of the inflatable sock is an attachment mechanism. An inflation canister is attached to the attachment mechanism and is configured to inflate the inflatable sock into an inflated state from a deflated state. The aforementioned bag contains the inflatable sock. The bag includes an interior surface and an exterior surface. On the exterior surface of the bag is a fastener configured to close an interior volume of the bag, a handle coupled to the exterior surface of the bag, and a series of loop fastener strips. The inflatable antennas disclosed herein may be provided in various other assemblies. The inflatable antenna assembly may include the capability of efficient storage of an inflatable antenna, where the inflatable antenna may assume an inflated state only in emergency situations. The inflatable antennas described herein are efficient with increased range while also being stowable in a small volume. Potential applications for the inflatable antennas and assemblies described herein include marine, military, emergency/rescue, camping, developing nation/remote area infrastructure, and shipping.

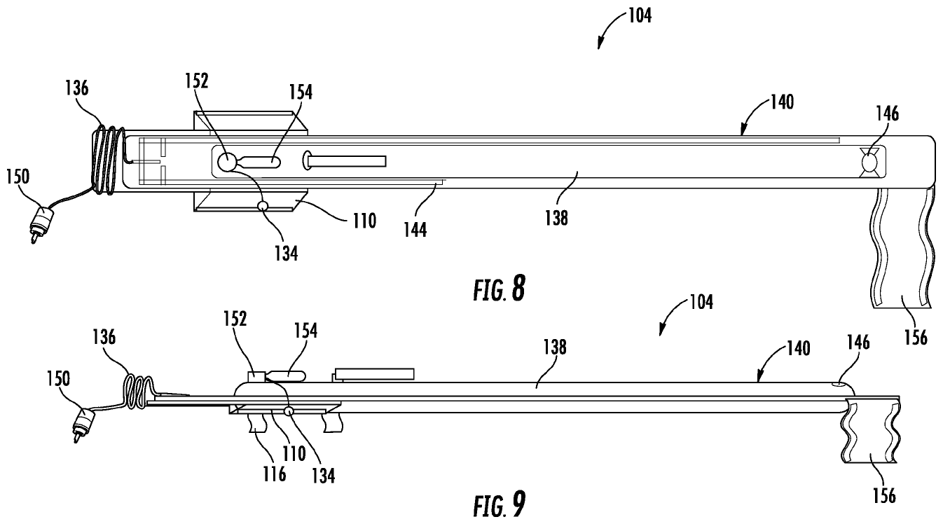

In some embodiments, as shown in FIGS. 8 and 9, the inflatable antenna assembly 100 may include an inflatable antenna 104 configured to assume an inflated state. For example, the inflatable antenna 104 may have a deflated state and an inflated state. As used herein, the phrase “inflated state” refers to the inflatable antenna being in an expanded shape due to gas or liquid substantially filling the interior volume of the inflatable antenna. As used herein, the phrase “deflated state” refers to the antenna being substantially empty of an expanding material such as gas or liquid. In some embodiments, as shown in FIGS. 5, 8, and 9, the inflatable antenna 104 includes an inflatable sock 138 (e.g., bladder, container) configured to expand into a predefined shape. For example, the inflatable sock 138 may expand when filled with gas to an inflated state 140 and form an elongated shape. The inflatable antenna 104 may be configured to manually or automatically inflate, such as by a suitable pump, user, or canister. In some instances, the inflatable sock 138 may have a rectangular cross-sectional shape. In other instances, the inflatable sock 138 may have a circular, square, elliptical, triangular, or another type of cross-sectional shape. The inflatable sock 138 may expand to about 1.5 meters long. In certain embodiments, the inflatable sock 102 has an inflated length of at least 1 meter. For example, the inflatable sock 138 in an inflated state 140 may have a length of from about 1 meter to about 10 meters, such as from about 1 meter to about 5 meters, or from about 1 meter to about 3 meters. As used herein, the term “about” means the specified value for a particular unit of measurement may be accurate with an increase or decrease of ten percent of the specified value.

In certain embodiments, the inflatable sock 138 may be disposed within a bag 102 or another suitable container, or associated with a suitable substrate or inflation mechanism in a deflated state 142. For example, the inflatable sock 138 in a deflated state 142 may be configured to be rolled or folded into a compact shape. For example, the inflatable sock 138 may be flat and flexible in its deflated state 142. In some instances, the inflatable sock 138 of the inflatable antenna 104 may be composed of plastic, rubber, neoprene or some other suitable material that is substantially impermeable to trapped gas or liquid. For example, the inflatable sock 138 may be substantially airtight, such that it can be inflated with air and maintain an inflated state 140 for a period (e.g., at least one day, or a period of about one day to about seven days). In certain embodiments, the inflatable sock 138 may include a sealable port configured to provide an inlet for the inflating air. For example, the inflatable sock 138 may be composed of nylon. For example, the fabric material may be a waterproof material. In another example, the fabric material may be a reflective or otherwise brightly colored and/or easy-to-see material. In some embodiments, the inflatable antenna 104 includes a light or other reflective features associated with the inflatable sock 138, such as to facilitate emergency locating.

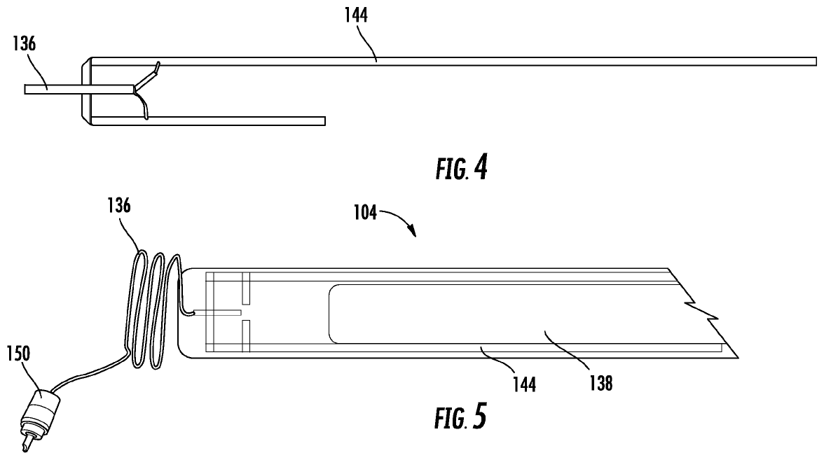

In some embodiments, as shown in FIGS. 4 and 5, the inflatable sock 138 of the inflatable antenna 104 contains an antenna 144. For example, the antenna 144 may attach to an interior surface of the inflatable sock 138. The antenna 144 may attach to an exterior surface of the inflatable sock 138. The antenna 144 may start adjacent to the bag 102 and extend away from the bag 102 up the inflatable antenna 104 exterior surface. For example, the antenna 144 may attach to the exterior surface of the inflatable sock 138 by adhesive or another fastener, and then covered with a layer of fabric. In some instances, the antenna 144 may attach to another surface of the inflatable antenna 104. In some instances, the antenna 144 may be embedded within stitching of the inflatable sock 138. In some instances, the antenna 144 may be embedded within the material of the inflatable sock 138. In some instances, the antenna 144 may attach to an exterior surface of the inflatable sock 138. In some instances, the antenna 144 may extend along the entire length of the inflatable sock 138. In some instances, the antenna 144 may wrap the inflatable sock 138. In other instances, the antenna 144 may follow one or more straight paths along the inflatable sock 138. In other instances, the antenna 144 may extend along only half a partial length, such as the distance of the length, of the inflatable sock 138. For example, the antenna 144 may extend about 70 percent of the length of the inflatable sock 138. For example, the antenna 144 may extend between about 50 percent to about 100 percent of the length of the inflatable sock 138. In certain embodiments, the antenna 144 has a length that is at least about 50 percent of the length of the inflatable sock, such as at least about 75 percent of the length of the inflatable sock, or at least about 85 percent of the length of the inflatable sock. For example, the antennas and assemblies described herein provide an efficiently stowable full-size antenna. For example, the antenna 144 may be about 130 centimeters to about 140 centimeters. In other instances, the antenna may be less than 130 centimeters or above 140 centimeters. For example, the antenna may be at least one meter in length but stowable in a package having a major dimension of one foot or less, such as about a 10 inch or smaller container. For example, these antennas may offer an unobtrusive and resilient full 3 dB VHF antenna that can be stored in a dimension of about 250 mm or less and inflated when required. Thus, these antennas may be used in areas where VHF signal transmission is needed and where it has historically been hard to get an antenna. Conventional emergency/temporary antennas are about 6 to about 8 inches long and have limited performance (e.g., about 1 dB gain). Thus, the antennas described herein offer increased performance. Moreover, traditional extendable antennas utilize a rigid telescoping design, which is prone to breakage. The flexible whip antenna designs described herein are relatively easy to store and quickly extend to full size, without the need for careful deployment of a telescoping antenna and the risk of damaging the antenna during deployment.

In some embodiments, as shown in FIG. 4, the antenna 144 is in a J-pole formation. As used herein, the phrase “J-pole formation” refers to an antenna in the formation of a “J” shape. A J-pole formation may include broadband coverage and low angle radiation pattern. The antenna 144 may be another type of antenna formation, including a bow tie, log-periodic dipole array, short dipole, dipole, monopole, loop, helical, Yagi-Uda, rectangular microstrip, planar inverted-f, corner, or parabolic reflector antenna configured to be connected to a radio receiver and/or transmitter. In some instances, the antenna 144 may be configured to transmit information. In other instances, the antenna 144 may be configured to receive information. The antenna 144 may be configured to transmit and receive signals. For example, the antenna 144 may be a very high-frequency antenna (VHF). As used herein, the phrase “very high frequency” refers to a range for radio waves of about 30 megahertz (MHz) to about 300 MHz. The antenna 144 may be tuned to a frequency of from about 30 MHz to about 300 MHz. For example, the antenna may be tuned to a frequency of about 156 MHz to about 162 MHz. In some instances, the antenna 144 may be high frequency. In other instances, the antenna 144 may be ultra-high frequency. The antenna 144 may have a gain of 3 decibels (dB). In some instances, the antenna 144 may have a gain of more or less than 3 dB. In one embodiment, the antenna 144 is a braided copper tape configured to be suitably flexible. For example, the copper tape may configured to fold when the inflatable sock 138 is in a deflated state 142. In other instances, the antenna 144 may not be flexible. The antenna 144 may be composed of another type of metal or metal alloy, such as aluminum. In some instances, the antenna 144 may be a flexible whip antenna.

In some embodiments, as shown in FIGS. 5, 8 and 9, the antenna 144 is coupled to a feed cable 136 configured to transfer information between the antenna 144 and a transmitter (not shown) and/or radio receiver (not shown). The feed cable 136 may be a radio frequency (RF) feed cable for the antenna 144. As used herein, the phrase “feed cable” refers to a cable that carries radio signals from a radio antenna to a transmitter or receiver. In some instances, the feed cable 136 is a coaxial cable. For example, the coaxial feed cable 136 may include two circular conductors, where one conductor is located within another conductor. In other instances, the feed cable 136 may be a ladder line. For example, the ladder line may be a feed cable 136 having two parallel wires separated by insulating material. In some embodiments, the feed cable 136 has an impedance value of 50 ohms. In other embodiments, the feed cable 136 has an impedance greater than or less than 50 ohms. At the end of the feed cable 136 may be a connector 150 that attaches to a radio or transmitter (not shown). In some instances, the connector 150 may be an ultra high frequency (UHF) connector. In other instances, the connector 150 may be another type of connector such as Subminiature Version A, Female Version A, Bayonet Neill-Concelman, Threaded Neill-Concelman, or Type N connector. The connector 150 may fit within the bag 102 and be configured to plug into a receiver or transmitter.

In some embodiments, as shown in FIGS. 8 and 9, the inflatable antenna assembly 100 includes a light 146. For example, the light 146 may be a light-emitting diode. The light 146 may be disposed at one end of the inflatable antenna 104. In some instances, the light 146 may be a different type of light, such as a fluorescent tube, a neon lamp, a high-intensity discharge lamp, a low-pressure sodium lamp, a metal halide lamp, a halogen lamp, a compact fluorescent lamp, or an incandescent lamp. In some instances, the inflatable antenna assembly 100 may have one light 146. In other instances, the inflatable antenna assembly 100 may have multiple lights disposed along the interior and/or exterior surfaces of the inflatable antenna 104 and/or bag 102.

In some embodiments, as shown in FIG. 9, the inflatable antenna assembly 100 includes a flag 156 configured to improve the visibility of the inflatable antenna 104. For example, the flag 156 may be a flexible material and lined with reflective material. For example, the flexible material may be a fabric such as cotton, linen, nylon, or other fabric. The reflective material on the flag 156 may be a fluorescent fabric. For example, having the flag 156 at one end of the inflatable antenna may increase visibility in case of rescue or signaling distress.

In some embodiments, as in FIGS. 8 and 9, the inflatable antenna 104 includes an attachment port 152, an inflation canister 154, and a firing pin 134. In one method, the inflation canister 154 is attached to the attachment port 152 and the firing pin 134 may be pulled to puncture the inflation canister 154. The inflation canister 154 may then force the inflatable sock 138 to assume an inflated state 140. In some instances, the attachment port 152 may be a one-way breathable port configured to receive air within the inflatable sock 138. In other instances, the attachment port 152 may be a two-way breathable port configured to receive and release air from within the inflatable sock 138. For example, the attachment port 152 may be a ball valve, butterfly valve, check valve, diaphragm valve, directional valve, float valve, knife valve, globe valve, pinch valve, needle valve, poppet valve, or plug valve. The inflatable antenna assembly 100 may have one valve or may have multiple valves along the exterior of the inflatable antenna 104.

The attachment port 152 may be configured to be coupled to a canister 154 filled with gas (i.e., in fluid communication with). In one embodiment, the canister 154 may be a carbon dioxide canister configured to be sealed until punctured by the firing pin 134. The canister 154 may be filled with another gas, such as hydrogen. In some instances, the canister 154 may be for one-time use. In other instances, the canister 154 may be refillable for multiple uses. In other instances, the inflatable sock 138 may couple to a pump configured to inflate the inflatable sock 138. The canister 154 may be a cylinder shaped to store within the bag 102 and be adaptable for replacement. For example, the cylinder may narrow at one end to attach to the attachment port 152. The narrow end of the canister may be a circular port (not shown) covered by a thin metal skin or seal. The firing pin 134 may puncture the circular port to release the gas within the canister 154. In some instances, the firing pin 134 is positioned between the canister 154 and the attachment port 152 to release air inside canister into the attachment port 152. In other instances, the firing pin 134 is located in the bag 102 and may be manually used to puncture the canister 154.

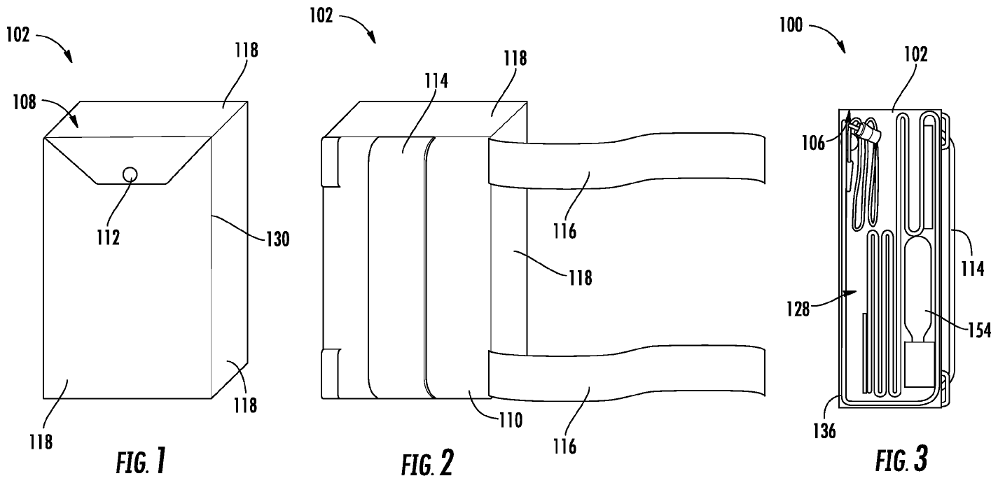

In some embodiments, as in FIGS. 1-3, an inflatable antenna assembly 100 is provided. The inflatable antenna assembly 100 includes a bag 102, an inflatable antenna 104, and, optionally, a series of other accessories contained on the interior and exterior of the bag 102. In some instances, the bag 102 may include an interior surface, interior volume 106, and an exterior surface 108. In some instances, the bag 102 may include multiple interior compartments (not shown) (e.g., pockets and/or dividers within the bag 102). The interior surface 106 and the exterior surface 108 may contain a variety of accessories. For example, the inflatable antenna assembly 100 bag 102 may contain the inflatable antenna 104 within or on the interior surface 106 along with any additional accessories, such as flashlights, whistles, lighters, flares, knives, rations, or other survival supplies. In some embodiments, as shown in FIG. 2, the exterior surface 108 of the bag 102 includes a stiffened portion 110, a fastener 112, a handle 114, and a series of loop fastener strips 116, among other accessories. For example, the exterior surface 108 of the bag 102 may contain reflectors, mounting apparatuses, pockets, or other structures on the bag 102. For example, the exterior surface 108 of the bag 102 may include a mounting fastener (not shown), such as a tie, cuff, buckle, clip, or other fastener. The bag 102 may be rigid or flexible. In some instances, the bag 102 may be nylon. In other instances, the bag 102 may be cotton, linen, wool, silk, rayon, acetate, acrylic, polyester, or some combination therein. In certain embodiments, the bag 102 may have a major dimension of about 10 inches or less. One benefit to the bag 102 being composed of nylon fabrics may be the resistance to wind and water damage.

In some embodiments, as shown in FIGS. 1-2, the bag 102 includes a plurality of walls 118 shaped as a rectangular prism. The plurality of walls 118 may form another shape, such as a cube, pyramid, cylinder, or other shape. In some instances, the plurality of walls 118 may all be rigid, solid surfaces. In other instances, some of the plurality of walls 118 may be rigid and some of the plurality of walls 118 may be flexible. For example, one wall of the plurality of walls 118 may be a stiffened portion 110. As used herein, the terms “stiffened portion” means the element is rigid under standard environmental conditions no matter the position of the element. In some instances, the stiffened portion 110 provides for a rigid base to allow for improved handling and/or inflation. In other embodiments, every wall in the plurality of walls 118 may be flexible. The plurality of walls 118 may form an interior volume 128. In some instances, the interior volume 128 may be open to the outside environment. That is, the inflatable antenna 104 may be coupled only to the stiffened portion 110 that provides partial containment or partial coverage of the antenna. In some embodiments, as shown in FIG. 1, the interior volume 128 of the bag 102 is closed to the outside environment. In some embodiments, a hatch, door, flap, or other suitable structure may be provided to allow for selective access to the interior volume 128. For example, one of the walls in the plurality of walls 118 may actuate about an axis (not shown) to open or close the interior volume 128. For example, one of the walls may include a fastener 112 configured to snap onto another wall to close the interior volume 128. The fastener 112 may be various types of other attachment mechanisms configured to close the interior volume. For example, the fastener 112 may be a hook-and-loop surface, button, press studs, magnetic snaps, or other attachment mechanism between two walls of the bag 102. In some instances, the plurality of walls 118 may join together by a similar attachment mechanism. For example, each seam 130 in the plurality of walls may have a hook-and-loop attachment between two walls to form the seam 130. One benefit to a hook-and-loop attachment mechanism between two walls may include the walls being easily removed from the bag 102 to release the contents of the bag 102. In other instances, the seams 130 may be formed by buttons, stitching, adhesive, or some other attachment mechanism.

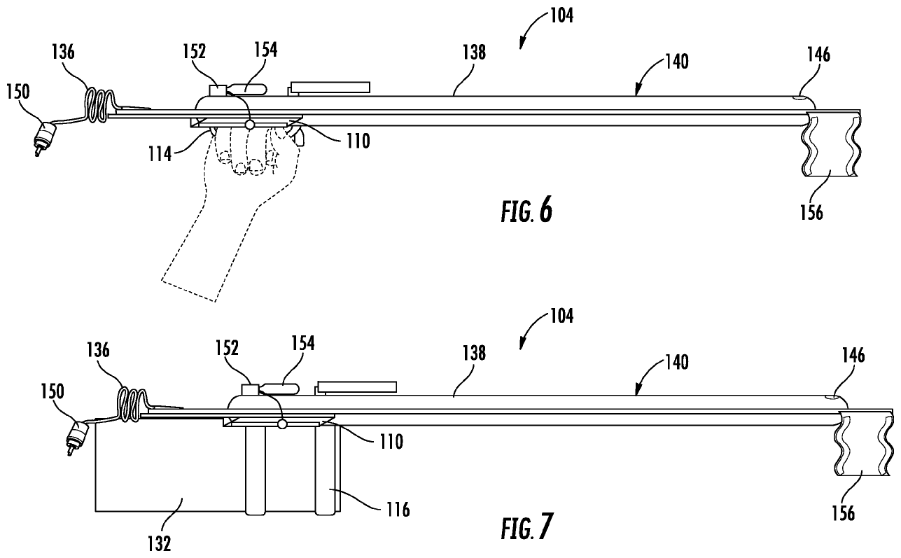

In some embodiments, as shown in FIG. 2, the stiffened portion 110 of the bag 102 includes several accessories disposed thereon. For example, the stiffened portion 110 may include a handle 114 and a series of loop fastener strips 116. The handle 114 may attach to one wall of the plurality of walls 118. For example, the handle 114 may be attached to the stiffened portion 110 of the bag 102. The handle 114 may be configured to be held by a user. For example, when the seams 130 of the bag are ripped apart, the interior volume 128 opened, and the inflatable antenna 104 expanded, a user may hold onto the handle to raise, lower, or adjust the positioning of the inflatable antenna 104 (e.g., as shown in FIG. 6).

In some embodiments, as shown in FIG. 2, the stiffened portion 110 includes a series of loop fastener strips 116 configured to attach the bag 102 to a structure 132. In some instances, a structure may include an inflatable life raft, a boat, a shipping container, or other suitable structure. For example, each loop fastener strip 116 may be a flexible fabric coupled to the bag 102 at one end and extend therefrom. The loop fastener strip 116 may wrap around a structure 132 (e.g., as shown in FIG. 7) to temporarily couple the inflatable antenna assembly 100 to a single, stable position. For example, the loop fastener strip 116 end, opposite the end coupled to the bag 102, may wrap around a structure 132 and attach to a fastener on the bag. For example, the bag 102 may have the loop portion of a hook-and-loop attachment mechanism, and the loop fastener strip 116 may include the hook portion of the hook-and-loop attachment mechanism. In some instances, the hook-and-loop mechanism may be disposed on the bag 102 and loop fastener strip 116 in another fashion.

In some embodiments, as shown in FIG. 3, the bag 102 includes an inflatable antenna 104 and other accessories within the bag 102. The inflatable antenna 104 within the bag may be in a deflated state, and each of the accessories may fit within the closed interior volume 128 (e.g., as shown in FIG. 1). For example, an inflation canister 154, firing pin 134, feed cable 136, and other accessories may be disposed therein.

While the disclosure has been described with reference to a number of embodiments, it will be understood by those skilled in the art that the disclosure is not limited to such disclosed embodiments. Rather, the disclosed embodiments can be modified to incorporate any number of variations, alterations, substitutions, or equivalent arrangements not described herein, but which are commensurate with the scope of the disclosure.

1. An inflatable antenna, comprising:
an inflatable sock having an inflated state and a deflated state, wherein the inflatable sock assumes an elongated inflated shape in the inflated state;
an antenna extending along a length of the inflatable sock; and
an attachment port configured for operable connection to an inflation mechanism.

2. The inflatable antenna of claim 1, wherein the antenna is a flexible whip antenna.

3. The inflatable antenna of claim 1, wherein the antenna extends between about 50 percent to about 100 percent of the length of the inflatable sock.

4. The inflatable antenna of claim 1, wherein the inflatable sock has an inflated length of at least 1 meter.

5. The inflatable antenna of claim 1, wherein the antenna has a length of at least 1 meter.

6. The inflatable antenna of claim 1, wherein the antenna extends along an inner surface of the inflatable sock.

7. The inflatable antenna of claim 1, wherein the antenna is a very high-frequency antenna.

8. The inflatable antenna of claim 7, wherein the very high-frequency antenna is tuned to a frequency of about 30 MHz to about 300 MHz.

9. The inflatable antenna of claim 7, wherein the antenna has a gain of at least 3 dB.

10. The inflatable antenna of claim 1, further comprising a light coupled to the inflatable sock.

11. The inflatable antenna of claim 1, wherein the inflatable sock has an inflated length of about 1 meter to about 10 meters.

12. The inflatable antenna of claim 1, wherein the antenna comprises a braided copper tape.

13. The inflatable antenna of claim 1, wherein the antenna within the inflated sock in the inflated state forms a J-pole antenna.

14. The inflatable antenna of claim 1, further comprising:
an inflation canister coupled to the attachment port and configured to inflate the inflatable sock to assume the inflated state; and
a firing pin coupled to the canister, wherein the firing pin is configured to selectively puncture a seal of the canister to inflate the inflatable sock.

15. The inflatable antenna of claim 1, further comprising a feed cable coupled to the antenna, wherein the feed cable is configured to transfer information between the antenna and a receiver.

16. The inflatable antenna of claim 1, further comprising a feed cable coupled to the antenna, wherein the feed cable is configured to transfer information between the antenna and a transmitter.

17.-22. (canceled)

23. An inflatable antenna assembly, comprising:
an inflatable antenna comprising an inflatable sock having an elongated shape, an antenna extending along a length of the inflatable sock, and an attachment port; and
an inflation mechanism configured for operable attachment to the attachment port, the inflation mechanism configured to selectively inflate the inflatable sock.

24.-28. (canceled)

29. An inflatable antenna assembly, comprising:
a bag comprising a stiffened portion; and
an inflatable antenna coupled to the stiffened portion within the bag.

30. The inflatable antenna assembly of claim 29, wherein the inflatable antenna comprises:
an inflatable sock having an interior surface and an exterior surface;
an antenna extending along the inflatable sock, wherein the antenna forms a J-pole antenna when the inflatable sock assumes an inflated state;
an attachment mechanism coupled to the exterior surface; and
an inflation canister coupled to the attachment mechanism, the canister comprising a firing pin configured to selectively puncture the inflation canister.

31. The inflatable antenna assembly of claim 29, wherein the bag comprises:
a canvas fabric coupled to the stiffened portion defining an interior volume;
a holding loop coupled to the stiffened portion; and
a series of loop fastener strips coupled to the stiffened portion.

32.-34. (canceled)
